(19) United States
(12) Patent Application Publication
(10) Pub. No.: US 2024/0168784 A1
(43) Pub. Date: May 23, 2024

(54) PROVIDING INTEGRATED CIRCUIT FUNCTIONALITY COVERAGE INDICATORS USING STATE SEQUENCE DETECTORS

(71) Applicant: HEWLETT PACKARD ENTERPRISE DEVELOPMENT LP, Spring, TX (US)

(72) Inventors: Naysen J. Robertson, Roseville, CA (US); Samuel Gonzalez, Spring, TX (US); David A. Young, Spring, TX (US); Theodore F. Emerson, Spring, TX (US); Nathaniel W. Jansen, Spring, TX (US)

(21) Appl. No.: 18/058,127

(22) Filed: Nov. 22, 2022

(51) Int. Cl. G06F 9/455

(52) U.S. Cl. CPC G06F 9/45529

(57) ABSTRACT

A process includes emulating, by a programmable logic device, a hardware component to provide an emulated hardware component. The emulated hardware component is capable of exercising the predetermined functionality. The process includes testing the emulated hardware component. The process includes determining, by the programmable logic device, whether the emulated hardware component exercised the predetermined functionality during the test. The determination includes, responsive to the testing, detecting, by a state sequence detector of the programmable logic device, whether the emulated hardware component sequenced through a plurality of states associated with the predetermined functionality. The process includes, responsive to the detection of whether the emulated hardware component sequenced through the plurality of states, generating, by the programmable logic device, an indicator representing a coverage of the predetermined functionality by the testing.

### BACKGROUND

Electronic design automation (EDA) tools may be used to design an integrated circuit (IC) and simulate, at one or more abstraction levels, behaviors of the IC design. EDA tools may further be used to verify the IC design through simulation-based testing. Simulation-based testing of an IC design may not invoke or exercise all features and capabilities of the IC design.

### BRIEF DESCRIPTION OF THE DRAWINGS

FIG. 1 is a block diagram of an emulation-based testing environment that includes a programmable logic device (PLD) that provides an emulated device under test (DUT) and includes functional coverage group (FCG) state sequence detectors to provide functionality coverage information according to an example implementation.

FIG. 2 depicts a state diagram of an FCG state sequence detector according to an example implementation.

FIG. 3 is a flow diagram depicting a process to initialize an FCG state sequence detector according to an example implementation.

FIG. 4 is an illustration of an FCG configuration table according to an example implementation.

FIG. 5 is a flow diagram of a process to create a programmable logic device having an FCG engine according to an example implementation.

FIG. 6 is a block diagram illustrating a system having computer platforms with FCG engines that track functionality usages and send corresponding usage metrics to a remote computer system for analysis according to an example implementation.

FIG. 7 is a flow diagram depicting a process to use a programmable logic device to emulate a hardware component, test the emulated hardware component and provide an indicator representing coverage of a predetermined functionality according to an example implementation.

FIG. 8 is a block diagram of an apparatus having a hardware device capable of exercising a predetermined functionality and a state sequence detector to provide an indicator of whether the hardware device exercised the predetermined functionality according to an example implementation.

FIG. 9 is a block diagram of a programmable logic device that includes elements to provide an emulated device and provide a state sequence detector to provide an indicator of a functional coverage associated with a predetermined functionality according to an example implementation.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

One approach to verify an integrated circuit (IC) design is to test a design under test (DUT) that corresponds to the IC design. In this context, verifying the IC design generally refers to evaluating the IC design for purposes of determining whether the IC design functions as intended. As an example, verifying an IC design may include testing the DUT to determine whether the IC design meets design specifications. As another example, verifying an IC design may include testing the DUT for purposes of identifying defects in the IC design and the extent of the defects.

A DUT may be an actual, physical manifestation of the IC design. For example, a DUT for a corresponding IC design may be an IC that is fabricated based on the IC design. As a more specific example, a DUT may be an IC that corresponds to the IC design and is fabricated in an unpackaged die on a semiconductor wafer. As another example, a DUT may be a semiconductor package (or “chip”) that contains a die on which an IC that corresponds to the IC design is fabricated.

A DUT may be an emulated DUT that is a prototyped version of the IC design and is provided by hardware emulation. In this context, hardware emulation of an IC refers to a process in which a hardware device other than the corresponding fabricated IC imitates, or emulates, behaviors of the fabricated IC. For example, an IC design may be prototyped by programming a programmable logic device (PLD) to provide an emulated DUT that imitates, or emulates, behaviors of the IC design. In the context used herein, a “PLD” refers to a reconfigurable logic component that may be specifically configured, or programmed, to have one or multiple functions. For the case of an emulated DUT, a PLD may be programmed, for example, to emulate different blocks, modules and/or subsystems of the IC design. A complex programmable logic device (CPLD), a field programmable gate array (FPGA) and an erasable programmable logic device (EPLD) are examples of PLDs.

A DUT may be a virtual device, or simulated DUT. In this manner, an IC design may be modeled and behaviors of the IC design may be observed through the execution of simulation software. A simulated DUT may correspond to one of many different abstractions of the IC design. As an example, a simulated DUT may correspond to a hardware description language (HDL)-based description of the IC design using register-transfer-level (RTL) modeling, and an RTL simulation tool may create behaviors of the IC design based on the RTL modeling. An RTL model describes the clocked behavior of the IC design in terms of data transfers between storage elements in sequential logic and combinatorial logic.

A simulated DUT may correspond to an abstraction of the IC design, which is higher than, lower than, or equal to an RTL abstraction. For example, a simulated DUT may correspond to a higher-level System Verilog-based description of the IC design. As another example, a logic synthesizer may be used to, from the IC design's RTL description, generate a netlist that describes IC design at a logic gate level, and a logic gate simulation tool may simulate behaviors of an IC design at the logic gate level. As another example, an analog simulation tool may simulate behaviors of an IC design at the transistor level.

It may be beneficial to verify a particular IC design by testing both simulated and emulated DUTs before the fabrication of the IC. That way, changes and redesigns to the IC design may be made without incurring the time and costs involved in refabricating the IC. A particular benefit of testing an emulated DUT is that the emulated DUT is able to exercise, in parallel, large portions of a complicated IC functionality and do so at orders of magnitude greater performance than a simulated DUT. Due to the ever-increasingly complexity of modern IC designs, the testing of a DUT may not exercise (and may not be expected to exercise) all of the functionalities of the DUT. Accordingly, the testing may not verify whether some functionalities of the DUT were invoked or exercised as intended by the testing.

In the context used herein, a “functionality” of a DUT refers to a group of one or multiple features and/or capabilities of the DUT (i.e., features and/or capabilities of the IC design). A functionality may correspond to any of a number of different hierarchical levels of the IC design's architecture. For example, a given functionality may correspond to features or capabilities of a bus interface, a finite state machine, a memory, a processing core, or other component of a functional block or module of the IC design. As another example, a given functionality may correspond to a particular set of node logic levels and clock signal transitions. As another example, a given functionality may correspond to features and/or capabilities corresponding to communications between functional blocks or modules of the IC design. As another example, a given functionality may correspond to features and/or capabilities corresponding to communications between the IC design and an external component. As another example, a given functionality may correspond to features and/or capabilities corresponding to one or multiple subsystems (e.g., subsystems that each containing multiple functional blocks or modules of the IC design).

Testing of an IC design may not, as a practical matter, cover all functionalities of the IC design, especially when the design is relatively complex, such as a design for a system on chip (SoC) or a relatively complex application specific integrated circuit (ASIC). In this context, a test “covering” a particular functionality refers to the test invoking or exercising the functionality a predefined number of times. The number of times may be specific to the particular functionality. The testing process may provide insights, called “functional coverages,” which represent whether or not certain functionalities were covered by the testing. Functional coverage knowledge may be beneficial for purposes of determining if the past testing of an IC design is adequate or whether the IC design should be further evaluated by more testing. Moreover, functional coverage knowledge may instill confidence that important, or key, functionalities of the IC design are not subject to defects, bugs or vulnerabilities.

There may be a number of potential reasons why simulation-based testing of an IC design may not by itself meet functional coverage goals. For example, there may be challenges related to generating the appropriate input stimuli during the simulation to cover certain functionalities. As another example, the discrepancy between simulation time and the wall clock time (e.g., one second of wall clock time may equate to minutes, hours or even days of simulation time) may be a barrier to covering some functionalities. For example, an IC may be intended to be a component of a computer platform, and a simulation that covers the entire boot sequence of the computer platform may take days or even months of simulation time. As another example, certain functionalities may not be covered due to a lack of understanding of the behaviors of the components that are external to the IC design.

To improve functional coverages, hardware emulation-based testing may be used in conjunction with simulation-based testing. A hardware emulation-based test environment may include, for example, a PLD that provides an emulated DUT to prototype an IC design and test equipment that is connected to the external terminals of the PLD. Moreover, a hardware emulation-based test environment may include emulated and/or actual external components that are to communicate with the IC in the final system. The hardware emulation-based testing may cover certain key functionalities that are not covered by the simulation-based testing. Accordingly, testing of an IC design via simulation and emulation may cover more functionalities than either approach may cover on its own.

As compared to simulation-based testing, hardware emulation-based testing of an IC design may provide rather limited functional coverage information. Unlike simulation, access to internal elements (e.g., internal nodes, buses, counters, registers and memories) of the emulated DUT may be limited or unavailable. Therefore, although hardware emulation-based testing of an IC design may actually cover a given functionality, it may be challenging to verify this coverage.

In accordance with example implementations that are described herein, the testing of an IC design via a hardware emulation-based testing environment is enhanced by increasing the amount of functional coverage information that is provided by the environment. In accordance with example implementations, a PLD is programmed to emulate a DUT to form an emulated DUT. In accordance with example implementations, the PLD contains elements that are configured via the programming of the PLD to form programmed PLD elements (called “DUT elements” herein), which collectively provide the emulated DUT. In this manner, subsets of DUT elements may correspond to different functional blocks of the DUT.

As examples, a DUT element may be a logic gate, a flip-flop, a block of logic gates, a programmable interconnect, an input/output (I/O) block, a memory, a single bit or multi-bit node, a register, or a functional block (e.g., a microprocessor, an arithmetic logic unit (ALU), or a digital signal processor (DSP)). In accordance with example implementations, for purposes of programming the PLD to emulate a DUT, an HDL description (e.g., a very high-speed integrated circuit hardware description language (VHDL) description, a Verilog language description, or a higher-level language description) representing the DUT may be provided to synthesis software. The synthesis software may be used to transform the HDL description into a netlist that contains primitives that correspond to the DUT elements. The netlist may be converted into a bitstream representation used to program the PLD.

In accordance with example implementations, a given functionality may be represented by a state map, which is referred to herein as a functional coverage group (FCG) sequence of states (also called an “FCG sequence” herein). The states and transitions among the states may be represented by a state diagram, such as a directed graph. The vertices of the directed graph may correspond to respective states, and the edges of the directed graph may represent transitions among the states. In accordance with example implementations, the states of the FCG sequence may transition through a cycle (referred to herein as an “FCG cycle”). An initial state of the FCG sequence corresponds to the beginning of the FCG cycle, and a final state of the FCG sequence corresponds to the end of the FCG cycle.

In accordance with example implementations, a functionality is deemed to be covered during the testing if the functionality is exercised at least a predetermined minimum number of times during the testing. For this purpose, in accordance with example implementations, a given functionality may be represented by an associated FCG sequence of states and an associated cycle repeat count. The cycle repeat count defines a predefined minimum number of times for the FCG sequence to cycle before the associated functionality is considered to be covered. As an example, a cycle repeat count for a particular FCG sequence may be “one,” which means that the corresponding functionality is considered covered if the functionality is exercised one time during the testing. As another example, a cycle repeat count may be “four,” which means that the corresponding functionality is not considered covered until the functionality is exercised four times.

In accordance with example implementations, the coverage for any of a number of different functionalities may be represented by an associated FCG sequence and an associated cycle repeat count. As an example, a functionality may correspond to the response of a bus interface of an emulated DUT to a particular bus transaction scenario. For example, the bus interface may communicate with main central processing unit (CPU) cores and peripheral devices of a computer platform, and a particular functionality may correspond to a response of the bus interface to a specified access (e.g., a read access or write access) that is initiated by a particular peripheral. As an example, the states of the FCG sequence may include a state corresponding to a bus address phase in which the particular peripheral initiates the specified access, and another state of the FCG sequence may correspond to a bus data phase in which bus interface responds. As an example, this functionality may be considered covered if the functionality is exercised a minimum number of times (corresponding to a repeat count interval) greater than one. Repeatedly exercising the functionality during the testing may be beneficial for a number of different reasons. For example, repeatedly exercising the functionality may instill a level of confidence that the testing is adequate to identify potential issues (e.g., bus timing-related issues, environmental problems, problems corresponding to species of the defined functionality, or other problems).

As another example, the states of an FCG sequence for a particular functionality may correspond to a response of a component of an emulated DUT when a buffer of the component is full. As another example, the states of an FCG sequence for a particular functionality may correspond to a component of an emulated DUT recognizing and responding to an event by initiating a reset or a power down of the emulated DUT. As another example, the states of an FCG sequence for a particular functionality may correspond to an emulated DUT handling a certain set of events related to a boot or power up of the emulated DUT or a boot or power up of an external system. As another example, the states of an FCG sequence for a particular functionality may correspond to an emulated DUT communicating messages with a particular external component. As another example, the states of an FCG sequence for a particular functionality may correspond to actions taken by a component of an emulated DUT related to the component performing a security check. As another example, the states of an FCG sequence for a particular functionality may correspond to actions taken by a component of an emulated DUT when a security check by the component is interrupted by a reset or a power loss. As another example, the states of an FCG sequence for a particular functionality may correspond to the emulated DUT implementing a particular cache policy.

As another example, the states of an FCG sequence for a particular functionality may correspond to a remote host access function and a particular scenario associated with providing the remote host access function. As another example, the states of an FCG sequence for a particular functionality may correspond to a component controlling power conservation modes and a particular scenario associated with the transitioning between power conservation modes. As another example, the states of an FCG sequence for a particular functionality may correspond to a particular scenario associated with a bus retry mode.

As another example, the states of an FCG sequence for a particular functionality may correspond to a particular scenario associated with bus arbitration. As another example, the states of an FCG sequence for a particular functionality may correspond to the DUT responding to a particular hardware fault scenario. As another example, the states of an FCG sequence for a particular functionality may correspond to a particular scenario that occurs in connection with the checking of security credentials or the setting of an access privilege.

A particular functionality may be more basic or at a relatively lower-level than the foregoing high-level functionality examples. For example, the states of an FCG sequence for a particular functionality may correspond to validating that the registers that define a finite state machine transition in a particular state sequence. As an even lower-level example, a Register A and a Register B may correspond to respective D-type flip-flops. A state transition of a particular FCG sequence may occur when the D terminal of Register A is high (or a “logic one”) when the Q terminal of Register B is low (or a “logic zero”) at the rising edge of the clock terminal of both Register A and Register B.

In accordance with example implementations, in addition to being programmed to provide an emulated DUT, the PLD is further programmed to provide one or multiple FCG state sequence detectors. The FCG state sequence detector, in accordance with example implementations, is associated with a particular functionality of the emulated DUT. The FCG state sequence detector provides an associated FCG indicator that provides information relating to whether the associated functionality was covered (e.g., provides an indication of whether the associated functionality was exercised and/or provides an indication that the associated functionality was exercised a minimum number of times as defined by a cycle repeat count). In accordance with some implementations, the FCG state sequence detector is a finite state machine, which tracks the FCG states of the associated functionality for purposes of detecting FCG cycles and providing a coverage indicator for the associated functionality based on this detection.

In accordance with example implementations, the FCG state sequence detector is configured by an FCG configuration table, which is stored in a memory of the PLD. In general, the data that is stored in the FCG configuration table configures the FCG state sequence detector to detect FCG cycles during the testing of the emulated DUT and provide an FCG indicator in response to the FCG cycle detection. In accordance with example implementations, the FCG configuration table contains data that represents a sequence of FCG states associated with a particular functionality, and the FCG configuration table contains data that represents dependency conditions for transitions among the FCG states. Moreover, among its other features, in accordance with example implementations, the FCG configuration table may contain data that represents a cycle repeat count for the associated functionality.

As an example, in accordance with some implementations, the FCG state sequence detector provides an indicator that represents the number of times that the FCG state sequence detector detected an FCG cycle during a test of the emulated DUT. As another example, in accordance with some implementations, the FCG state sequence detector provides a functional coverage indicator that is a binary indication that represents whether or not the functionality was exercised at least a minimum number of times during the test, as defined by the cycle repeat count.

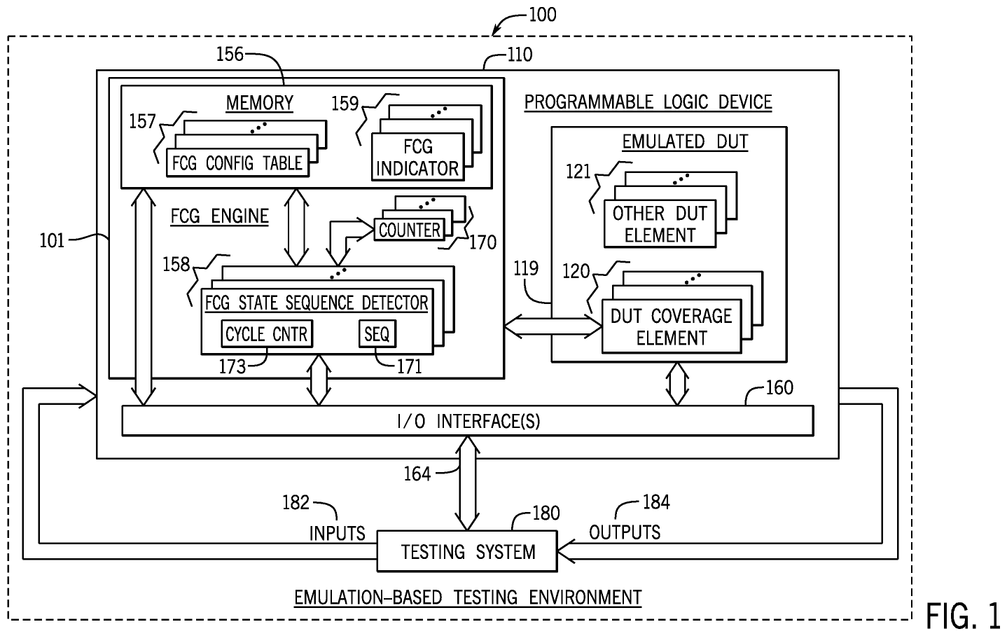

Referring to FIG. 1, as a more specific example, in accordance with some implementations, an emulation-based testing environment 100 may include a PLD 110 that is programmed to provide, among other possible components, an emulated DUT 119 and an FCG engine 101. In accordance with some implementations, the emulated DUT 119 may correspond to an IC design, such as a System on Chip (SoC), an Application Specific Integrated Circuit (ASIC) or other circuit.

The FCG engine 101, in accordance with example implementations, is a functional coverage monitoring infrastructure that provides FCG indicators 159 that represent whether associated respective functionalities of the emulated DUT 119 were covered during testing of the emulated DUT 119. In general, a given functionality being covered refers to the functionality being exercised a predefined minimum number of times during the testing. As further described herein, in accordance with some implementations, an FCG indicator 159 may specifically indicate a number of times that an associated functionality of the emulated DUT 119 was invoked or exercised during the testing. In accordance with further implementations, a given FCG indicator 159 may specifically indicate whether the associated functionality was exercised a predefined minimum number of times (e.g., the FCG indicator 159 may be set to a Boolean TRUE to represent that the functionality was exercised), as configured by a corresponding cycle repeat count. As further described herein, in accordance with some implementations, the FCG engine 101 includes one or multiple FCG state sequence detectors 158 and a memory 156.

The FCG state sequence detector 158, in accordance with example implementations, is a finite state machine that has a sequence 171 of states (called “FCG states” herein) that corresponds to a sequence of states of the associated functionality. The FCG state sequence detector 158 uses the sequence 171 to track cycles of the sequence of states of the associated functionality. As described further herein, the FCG state sequence detector 158 transitions between the FCG states of the sequence 171 responsive to certain dependency conditions being satisfied. A completion of the sequence 171, in accordance with example implementations, is referred to herein as an “FCG cycle” and means that the associated functionality has been exercised. In accordance with example implementations, the FCG state sequence detector 158 has its own clock domain, and the FCG state sequence detector 158 transitions between the FCG states of the sequence 171 synchronously with the clock domain. In accordance with example implementations, the FCG state sequence detector 158 synchronizes any signals (e.g., signals associated with DUT coverage elements 120, as further described below) that it receives with the detector's clock domain.

The FCG state sequence detector 158 may further include, in accordance with example implementations, a cycle repeat counter 173, which is used by the FCG state sequence detector 158 to track the number of times that the sequence 171 repeats. In accordance with example implementations, the number of times may be configured by a cycle repeat count. In accordance with example implementations, the FCG state sequence detector 158 may, responsive to a power on or reset of the PLD 110, initialize the cycle repeat counter 173 with the cycle repeat count, and the FCG state sequence detector 158 may decrement the cycle repeat counter 173 each time the sequence 171 completes (i.e., each time a corresponding FCG cycle is detected). In this way, in accordance with example implementations, when the cycle repeat counter 173 decrements to zero, the FCG state sequence detector 158 may stop tracking the associated functionality until the next power on or reset of the PLD 110 and set its FCG indicator to TRUE accordingly.

The FCG state sequence detector 158 provides an FCG indicator 159 to represent a coverage for the associated functionality. In accordance with some implementations, the FCG indicator 159 is a binary value, and the FCG state sequence detector 158 asserts (e.g., sets or changes from a Boolean FALSE to a Boolean TRUE) the FCG indicator 159 in response to the detected number of FCG cycles being equal to the cycle repeat count to specifically indicate that the associated functionality was covered. In accordance with further implementations, the FCG indicator 159 may be a multiple bit indicator that represents the number of detected FCG cycles. In this way, the FCG indicator 159, in accordance with example implementations, may specifically indicate the number of times that the associated functionality was exercised (or at least indicate the number of times until the minimum number of times is reached, depending on the particular implementation).

In accordance with example implementations, the memory 156 may store one or multiple FCG configuration tables 157. As an example, in some implementations, an FCG configuration table 157 may contain data records to configure a corresponding respective FCG state sequence detector 158. In accordance with some implementations, an FCG configuration table 157 may store records for multiple respective FCG state sequence detectors 158. In accordance with further implementations, an FCG configuration table 157 may store records for a single FCG state sequence detector 158. In accordance with example implementations, the records for a particular FCG state sequence detector 158 configure the detector 158 with a sequence 171 and a cycle repeat count. As also depicted in FIG. 1, the memory 156 may store one or multiple FCG indicators 159 that are provided by respective FCG state sequence detectors 158.

In general, the electrical components that form the memory 156, as well as other memories and storage media that are described herein, may be formed from non-transitory memory devices, such as semiconductor storage devices, flash memory devices, memristors, phase change memory devices, a combination of one or more of the foregoing storage technologies, and so forth. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

The FCG engine 101, in accordance with example implementations, may include multiple counters 170. In accordance with some implementations, each FCG state sequence detector 158 may be associated with its own respective set of counters 170. The set of counters 170, in accordance with example implementations, configure the associated FCG state sequence detector 158 to measure values of the DUT coverage elements 120 according to different intervals of time. The clock inputs of the set of counters 170 may be gated by different enable signals that establish different increment frequencies so that the counters 170 of the set may have different increment time resolutions.

For example, the enable signal may be a periodic single clock pulse to the clock domain in which the state sequence detector 158 and counter 170 are synchronous. In this way, relatively large periods of time can be tracked with a relatively small counter. As an example, the enable signals for a set of three counters 170 that are associated with a particular FCG state sequence detector 158 may be regulated so that the three counters 170 have increments corresponding to one millisecond, one microsecond and one second, respectively. In accordance with some implementations, an FCG state sequence detector 158 may use the count value of a particular counter 170 to trigger a measurement of a particular value of the DUT coverage elements 120. Therefore, the count values for different counters 170 may configure the values of the DUT coverage elements 120 to be measured at different time intervals. The measured values may, for example, control the evaluations of dependency conditions that control transitions between FCG states, as further described herein.

A testing system 180 may be coupled to the PLD 110 for purposes of testing the emulated DUT 119. The testing system 180 may include any of a number of digital and/or analog measurement and stimuli generation subsystems, such as digital signal generators, function generators, digital logic analyzers, oscilloscopes, waveform generators, multimeters, spectrum analyzers, network analyzers, serial decoders, serial encoders, as well as other and/or different test equipment.

The testing system 180 may provide various stimuli to test the emulated DUT 119 in the form of inputs 182. As examples, the inputs 182 may be control signals, address signals, signals or signal sequences representing requests, data signals representing predetermined values or parameters, as well as other stimuli. The testing system 180 may observe the responses of the emulated DUT 119 to the testing via one or multiple outputs 184 that are received from the PLD 110. As examples, the outputs 184 may be data signals, address signals, control signals, sequences, output data, values, signal patterns, data patterns, as well as other response indications.

In accordance with some implementations, the testing system 180 may model external components that interface or communicate with the emulated DUT 119. In accordance with example implementations, the testing system 180 may be the hardware platform and environment that a DUT 119 solution will ultimately target when the solution is released/productized. For example, the external components may be other components of the hardware platform and environment other than the IC that corresponds to the emulated DUT 119. The modeled external components may provide stimuli to the emulated DUT 119 to stimulate sequences and state spaces of the emulated DUT 119. In accordance with further example implementations, the emulation-based testing environment 100 may include one or multiple actual, physical components that are coupled to the emulated DUT 119 and are part of the system that is to include an IC that corresponds to the emulated DUT 119.

In accordance with example implementations, the PLD 110 includes DUT elements 120 and 121 that collectively encompass the emulated DUT 119. In accordance with some implementations, the emulated DUT 119 may correspond to an RTL abstraction of the IC design.

The DUT elements 120 and 121 may include, as examples, logic gates, flip-flops, counters, synchronous logic, combinatorial logic, interconnects, single bit and multiple bit nodes, wires, I/O blocks, functional blocks, as well as other and/or different elements of the PLD 110. As depicted in FIG. 1, the DUT elements 120 are “DUT coverage elements,” which provide values that are tracked, or monitored, by the FCG state sequence detectors 158 of the FCG engine 101 during the testing of the emulated DUT 119 for purposes of determining whether certain functionalities of the emulated DUT 119 were covered by the testing, as further described herein. As depicted in FIG. 1, the DUT elements 121 are the “other DUT elements 121” of the emulated DUT 119, which are not actively monitored by the FCG state sequence detectors 158 during the testing.

In accordance with example implementations, one or multiple other DUT elements 121, which are not actively monitored in a particular test execution may become DUT coverage elements 120 that are actively monitored in another test execution, and vice versa. In this manner, the designation of the DUT coverage elements 120 and the other DUT elements 121 may correspond to a particular programmed PLD 110 for a particular test execution. The same PLD 110 may be reprogrammed for one or multiple other test executions that may involve redesignating which DUT elements are and are not actively monitored.

As indicated at 164, the testing system 180 may be coupled to one or multiple I/O interfaces 160 of the PLD 110. The I/O interface 160 provides an offload path for downloading functional coverage information from the PLD 110, As described further herein, at the conclusion of the testing of the emulated DUT 119, the testing system 180 may communicate with the I/O interface 160 for purposes of retrieving data representing the FCG indicators 159. Moreover, the I/O interface 160 may provide an upload path in that prior to the testing, the I/O interface 160 may be used to upload the FCG configuration tables 157 into the memory 156 for purposes of configuring one or multiple FCG sequence detectors 158 of the FCG engine 101. As examples, the I/O interface 160 may conform to a network interface (e.g., Ethernet interface), a boundary scan interface (e.g., a Joint Test Action Group (JTAG) interface), a serial interface (e.g., a Serial Peripheral Interface (SPI) bus, an Inter-Integrated Circuit (I²C) bus or an Improved I²C (I³C) bus) or another communication interface. The I/O interface 160 may be dedicated for the testing purposes, in the case of an emulated DUT 119. As further described herein, in accordance with further example implementations, the I/O interface 160 may be part of a productized IC, and for these implementations, the I/O interface may be a shared active interface that is productized within the IC implementation of the DUT 119.

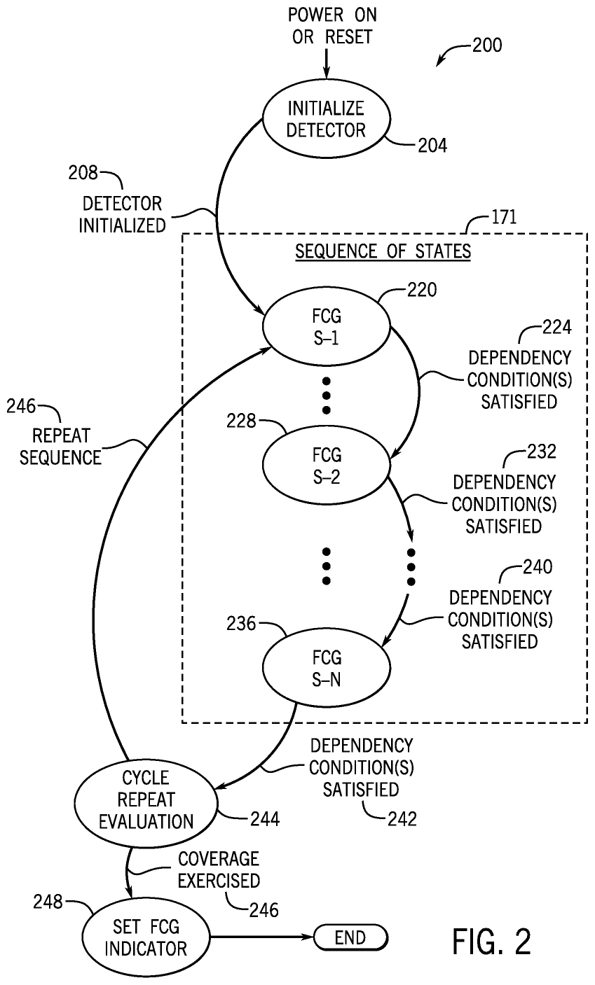

FIG. 2 depicts a state diagram 200 of an FCG state sequence detector according to example implementations. The FCG state sequence detector is associated with a particular functionality of an emulated DUT, and in accordance with example implementations, by operating per the state diagram 200, the FCG state sequence detector provides an FCG indicator to indicate a functional coverage for the associated functionality.

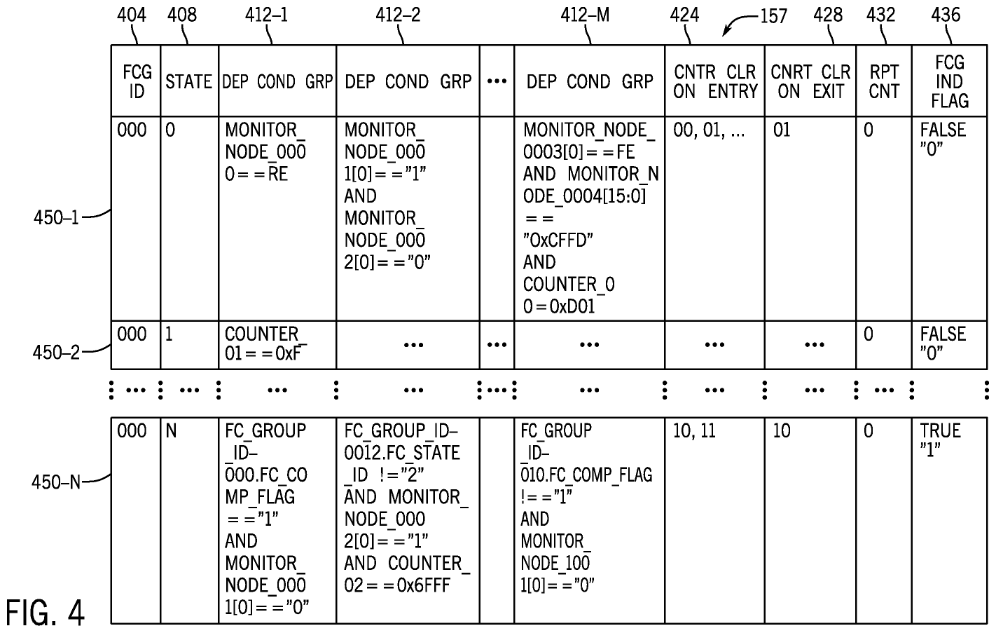

Referring to FIG. 2, in accordance with some implementations, the PLD may be powered on or reset at the beginning of a test of the emulated DUT, and in response to the power on or reset of the PLD, the state sequence detector transitions to an initialization state 204. For the example implementation depicted in FIG. 2, the associated functionality includes N states, and the initialization may include the FCG state sequence detector setting up a sequence 171 of N FCG states, which corresponds to a sequence of N states of the associated functionality. In accordance with example implementations, the FCG state sequence detector uses the sequence 171 to track when the corresponding functionality has been exercised. The exercising of the associated functionality, in accordance with example implementations, corresponds to one complete transition, or cycle (herein called an FCG cycle), of the sequence 171. An example FCG configuration table 157 is depicted in FIG. 4 and described further below. Also in the initialization state 204, the FCG state sequence detector may initialize a cycle repeat counter with cycle repeat count (from the FCG configuration table), which represents the number of times for the sequence 171 to be repeated (e.g., the number of FCG cycles) for the associated functionality to be covered.

In general, the sequence 171 may correspond to a directed graph, where vertices of the directed graph correspond to respective FCG states. The edges of the directed graph correspond to FCG state transitions. Although FIG. 2 is a relatively simple example of a sequence 171 that corresponds to an acyclic directed graph and in which each FCG state of the sequence 171 has a single transition to another state, in accordance with further example implementations, the sequence 171 may be relatively more complex. For example, in accordance with further implementations, the sequence 171 may have a given FCG state that may, depending on the conditions, transition to two or more FCG states. As another example, in accordance with further implementations, the sequence 171 may correspond to a directed graph that has one or multiple directed cycles within the graph. Regardless of its particular form, the sequence 171 has an initial FCG state (e.g., the FCG S-1 state 220 of FIG. 2) and a final FCG state (e.g., the FCG S-N state 236 of FIG. 2).

As depicted in FIG. 2, in accordance with example implementations, responsive to the FCG state sequence detector being initialized (as depicted at 208), the FCG state sequence detector transitions from the initialization state to the FCG S-1 state 220, which is the first FCG state of the sequence 171. The FCG state sequence detector evaluates one or multiple dependency conditions 224 for purposes of determining whether to transition from the FCG S-1 state 220 to the next FCG S-2 state 228.

In accordance with some implementations, the dependency condition(s) 224 are defined by the FCG configuration table. Moreover, in accordance with some implementations, for the case of multiple dependency conditions being associated with a given FCG state, the FCG state sequence detector performs a logical OR of the dependency conditions to determine whether at least one of the dependency conditions is satisfied to cause a transition to the next FCG state. For the case of the FCG S-1 state 220, if a dependency condition 224 (out of potentially multiple dependency conditions 224) is satisfied, then the FCG state sequence detector transitions from the FCG S-1 state 224 to the FCG S-2 state 228.

A dependency condition, in accordance with example implementations, may be a condition that is decided, or evaluated, by applying combinatorial logic to the value(s) provided by one or multiple DUT coverage elements. In accordance with example implementations, the evaluation of a given dependency condition may result in either a Boolean TRUE that triggers a transition to the next FCG state of the sequence 171 or a Boolean FALSE implying no state transition for the active cycle.

A dependency condition being satisfied may correspond to one or multiple particular events occurring with or in the emulated DUT. In general, an event may be associated with or correspond to an indicator or any feature or capability of the emulated DUT. As examples, a given dependency condition may depend on the logical combination of one or multiple logic level transitions (e.g., rising edge transitions and/or falling edge transitions); one or multiple counter values; one or multiple node logic states; one or multiple signal states; or other indication(s) or signal(s) provided by the DUT coverage elements.

In accordance with some implementations, a dependency condition may be whether one or multiple other FCG sequences have achieved their coverage states (e.g., one or multiple FCG indicators 159 are set to TRUE). For example, a first FCG state sequence may rely on a second FCG state sequence being covered before the first FCG state sequence proceeds with other FCG sequence states.

As an example, an event may be a transmission or a reception of a signal. As another example, an event may be a transmission or a reception of a message. As another example, an event may be an assertion of an error signal. As another example, an event may be a counter reaching a threshold value. As another example, an event may be a certain bus access by particular entity. As another example, an event may be a buffer full signal. As another example, an event may be, a fault condition. As another example, an event may be a security check failure. As another example, an event may be a validation failure. As another example, an event may be an authentication failure. As another example, an event may be an unstable power detection. As another example, an event may be a particular branch at a decision point.

In the FCG S-2 state 228, the state sequence detector determines whether another set of dependency condition(s) 232 are satisfied and if so, the state sequence detector transitions to the next FCG state (not depicted in FIG. 2) of the sequence 171. The state sequence detector continues evaluating dependency conditions and based on these evaluations, transitioning among the FCG states until the state sequence detector reaches the Nth FCG S-N state 236, responsive to the dependency condition(s) being satisfied to transition from the previous FCG state, as depicted at 240. For this example, implementations, the FCG S-N state 236 is the final FCG state of the sequence. In accordance with some implementations, responsive to one or multiple dependency conditions 242 being satisfied, the state sequence detector transitions to a state 244 at which the state sequence detector evaluates, or determines, whether to repeat the sequence, as depicted at 246.

Although for the example sequence 171 that is depicted in FIG. 2, each state transition is to a new state of the sequence 171, in accordance with further implementations, a given state transition for a sequence 171 may be to a previous state. For example, in accordance with a further implementation, for another sequence 171, there may be a transition from state A to state B, a transition from state B to state C, and a transition from state C back to state A. As another example, for another sequence 171, depending on which dependency conditions are satisfied, from state A, there may be a transition to state B or a transition back to state A.

In accordance with some implementations, in the state 244, the state sequence detector decrements the cycle repeat counter, and if the cycle repeat count is non-zero, the state sequence detector transitions (as depicted at 246) back to the FCG S-1 state 220 to detect another FCG cycle. Otherwise, the state sequence detector has detected that the associated functionality was covered during the testing, and the state sequence detector transitions to a state 248 at which the state sequence detector sets the FCG indicator to represent the coverage.

In accordance with further example implementations, instead of providing a binary indication of whether or not the functionality was covered, the FCG indicator may be multiple bit value that represents a number of times that the functionality was exercised (e.g., the number of times up to the minimum established by the repeat count value or the number of times not restricted by a repeat count value). For these example implementations, the FCG state sequence detector may not have a state 248 to set the FCG indicator, as depicted in FIG. 2. Rather, the FCG state sequence detector, as part of the state 244, may update the multiple bit FCG indicator with the current number of times that the functionality has been exercised.

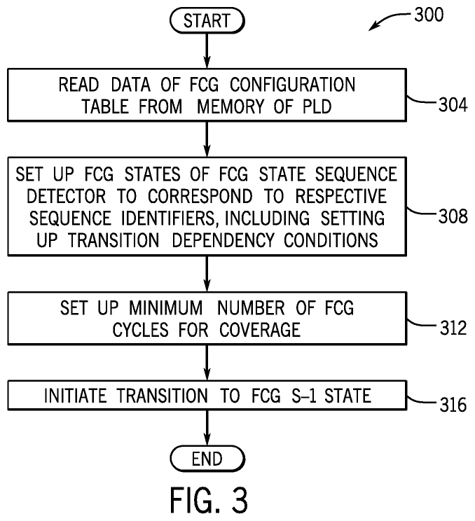

FIG. 3 depicts a process 300 to initialize an FCG state sequence detector according to an example implementation. In accordance with some implementations, the FCG state sequence detector or another component of the FCG engine may perform the process 300. Referring to FIG. 3, in accordance with some implementations, the process 300 includes reading (block 304) data of an FCG configuration table from a memory of a PLD. Next, pursuant to block 308, the process 300 includes, based on the data, setting up the sequence of FCG states. This may include, for example, creating the number of states specified by the data and setting up the dependency condition evaluations for each FCG state. Moreover, pursuant to block 312, the process 300 includes, based on the data from the FCG configuration table, setting up the minimum number of FCG cycles (e.g., initializing the cycle repeat counter) for the functionality to be covered. Pursuant to block 316, the process 300 initiates the transition to the initial FCG state of the sequence.

FIG. 4 depicts the FCG configuration table 157, in accordance with example implementations. Referring to FIG. 4, the FCG configuration table 157 includes records 450 for configuring one or multiple FCG state sequence detectors. Example records 450-1, 450-2 and 450-N are specifically shown in FIG. 4 corresponding to N records 450 for configuring an FCG state sequence detector having a corresponding identification (ID) of “000” (as represented by an FCG ID field 404 of the N records 450).

Each record 450, in accordance with example implementations, has a field 408 that contains data, which corresponds to a particular FCG state. In accordance with example implementations, the records 450 for a particular FCG state sequence detector are sequentially ordered in the table 157 according to the sequential ordering of the corresponding FCG states. More specifically, for this example, the N records 450-1 to 450-N correspond to FCG states 1 to N, respectively.

The record 450 further has one or multiple dependency condition group fields 412 that contain data representing respective conditional dependencies for the associated FCG state. Stated differently, each field 412 of a given record 450 stores data that represents a conditional dependency that, if satisfied, triggers a transition from the FCG state that is associated with the given record 450 to the next FCG state that is associated with the next record 450 that follows the given record 450 in the table 157. The conditional dependencies may be based on states and values of DUT coverage elements (e.g., DUT coverage elements 120 of FIG. 1) as well as on FCG indicators, in accordance with example implementations.

For the example that is depicted in FIG. 4, the record 450-1 has M dependency condition groups, including specific example dependency condition groups 412-1, 412-2 and 412-M. These M dependency condition groups correspond to M dependency conditions, such that any of the dependency condition being satisfied triggers a transition from FCG state 0 associated with the record 450-1 to the FCG state 1 associated with record 450-2. Dependency condition group 412-1 of the record 450-1 specifies a state transition from the FCG state 0 to the FCG state 1 if a particular single bit node (MONITOR_NODE_0000[0]) has a rising edge. Dependency condition group 412-2 of the record 450-1 specifies a state transition from the FCG state 0 to the FCG state 1 if a particular single bit node (MONITOR_NODE_0001[0]) has a logic value of one and another single bit node (MONITOR_NODE_0002[0]) has a logic value of zero. Dependency condition group 412-M of the record 450-1 specifies a state transition from the FCG state 0 to the FCG state 1 if a particular single node (MONITOR_NODE_0003[0]) has a falling edge, a multi-bit node (MONITOR_NODE_0004[15:0]) has a certain value (0xCFFD) and a particular counter (COUNTER_00) has a certain value (0xD01).

The record 450-2, which is associated with the FCG state 1, has a single dependency condition group 412-1. The group 412-1 specifies a transition from the FCG state 1 to the FCG state 2 if a particular counter (COUNTER_01) has a certain value (0xF).

The record 450-N, which is associated with the final FCG state, FCG state N, contains M dependency condition groups 412-1 to 412-M for this example. Each of these dependency condition groups specifies a respective dependency condition that, if satisfied, corresponds to the end of the FCG sequence. Stated differently, if any of these conditional dependencies are satisfied with the FCG state sequence detector is in FCG state N, then the associated functionality has been exercised (corresponding to an FCG cycle).

In accordance with example implementations, a given dependency condition may be based on whether or not another functionality was covered and/or whether another functionality was exercised. More specifically, the dependency condition group 412-1 of the record 450-N specifies the end of the sequence if a particular FCG indicator (FC_GROUP_ID-000.FC_COMP_FLAG) is set to one (which represents the corresponding functionality has been exercised one time) and a particular single bit node (MONITOR_NODE_0001[0]) has a logic value of zero. The dependency condition group 412-2 of the record 450-N specifies the end of the sequence if a particular FCG indicator (FC_GROUP_ID-0012.FC_COMP_FLAG) is not equal to two (e.g., the corresponding functionality has not been exercised two times), a particular single bit node (MONITOR_NODE_0001[0]) has a logic value of one, and a particular counter (COUNTER_02) has a certain value (0x6FFF). The dependency condition group 412-M of the record 450-N specifies the end of the sequence if a particular FCG indicator (FC_GROUP_ID-0010.FC_COMP_FLAG) is not equal to one (e.g., the corresponding functionality has been exercised two times or has not been exercised) and a particular single bit node (MONITOR_NODE_1001[0]) has a logic value of zero.

In accordance with some implementations, the record 450 may include a field 424 that stores data that represents the identity(ies) of one or multiple counters (e.g., the counters 170 of FIG. 1) whose entry(ies) are to be cleared by the state sequence detector at the beginning of an FCG cycle. Moreover record 450 may include a field 428 that stores data that represents the identity(ies) of one or multiple counters whose entry(ies) are to be cleared by the state sequence detector at the conclusion of an FCG cycle. Field 432 of the record 450, in accordance with example implementations, includes the cycle repeat count. Field 436 contains data to identify the record 450 that corresponds to the final FCG state of the sequence. For this example, the fields 436 of the records 450-1 to 450-N−1 each contains a bit of “0,” and the field 436 of the record 450-N contains a bit of “1” to represent the record 450-N corresponds to the last FCG state of the sequence. In accordance with further example implementations, for purposes of conserving memory space, the field 436 may be implied by the end of the record to correspondingly imply the last FCG state of the sequence.

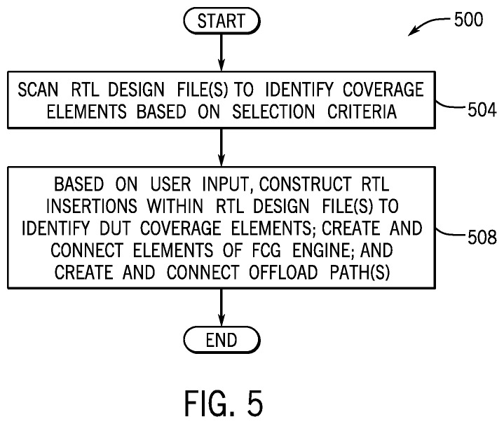

Referring to FIG. 5, in accordance with some implementations, a process 500 may be used to create a PLD coverage capture framework. As an example, the process 500 may be performed by a script or graphical user interface (GUI) tool that performs the process 500. In accordance with example implementations, a table-based approach may be used as input to one or multiple scripts that develop the framework. In accordance with example implementations, source Register Transfer Logic (RTL) files may be annotated by the configuration and setup scripts behind dedicated debug and coverage sections that are enabled when a compiler directive or hardware descriptor language define switch is invoked.

The process 500 includes scanning (block 504) one or multiple design files (e.g., RTL files) based on a user-defined selection criteria to identify one or multiple coverage elements within the DUT. The user input may further include user data that identifies specific DUT coverage elements and associated state transition coverage and event coverage associated with these elements. Based on the user input, pursuant to block 508, the process 500 includes constructing insertions (e.g., RTL insertions) within the design file(s) to create and connect the framework logic, storage primitives and offload path(s) for the identified coverage elements.

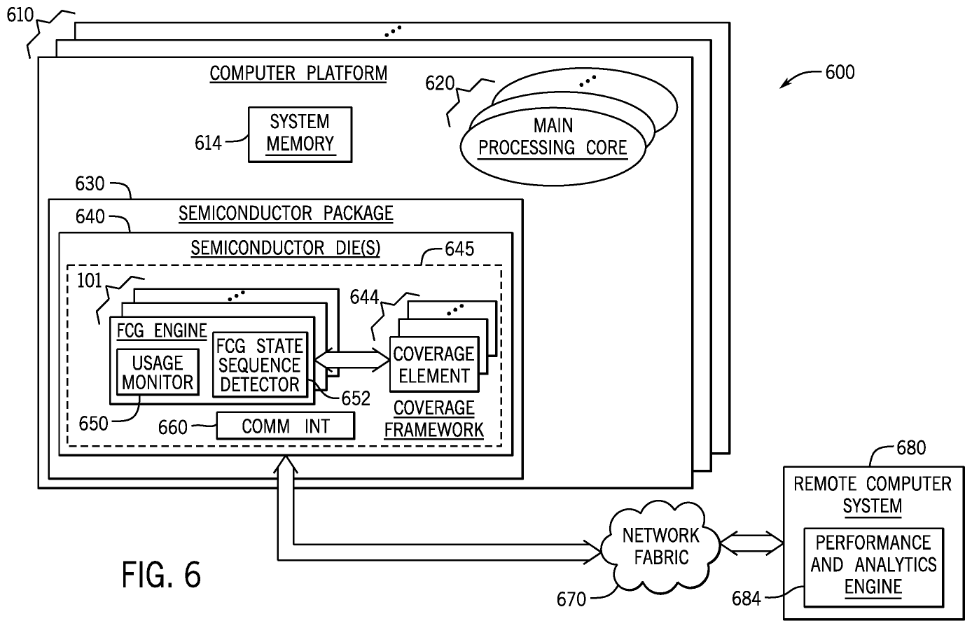

In accordance with some implementations, one or multiple FCG engines that contain FCG state sequence detector may be incorporated into a final, production ready integrated circuit. For example, FIG. 6 depicts a system 600 of one or multiple computer platforms 610, in accordance with example implementations.

The computer platform 610, in accordance with example implementations, is a modular unit, which includes a frame, or chassis. Moreover, this modular unit may include hardware that is mounted to the chassis and is capable of executing machine-readable instructions. A blade server is an example of the computer platform 610, in accordance with some implementations. The computer platform 610 may have a number of different other forms, in accordance with further implementations, such as a rack-mounted server, standalone server, a client, a desktop, a smartphone, a wearable computer, a networking component, a gateway, a network switch, a storage array, a portable electronic device, a portable computer, a tablet computer, a thin client, a laptop computer, a television, a modular switch, a consumer electronics device, an appliance, an edge processing system, a sensor system, a watch, a removable peripheral card, or, in general, any other processor-based platform.

As depicted in FIG. 6, in accordance with example implementations, a given computer platform 610 may include, among its other elements, one or multiple main processing cores 620 (e.g., central processing unit (CPU) processing cores, general graphics processing unit (GPU) cores, and so forth) and a system memory 614.

As depicted in FIG. 6, the computer platforms 610 may be coupled by network fabric 670 to a remote computer system 680. The network fabric 670 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

A performance and analytics engine 684 of the remote computer system 680 may, for example, acquire and analyze usage data metrics that are gathered from the computer platform 610. As an example, the usage data metrics may be used for purposes of performance analysis as well as other types of analyses (e.g., functional analysis, circuit utilization analysis, power analysis, security analysis or other analysis). In this manner, in accordance with example implementations, the performance and analytics engine 684 may analyze usage metric data provided by the computer platform 610 for purposes of determining characteristics (e.g., whether the functionalities are used, how often the functionalities are used, when the functionalities are used, a frequency of use of the functionalities, or other characterizing properties) of certain functionalities of the computer platform 610.

In accordance with example implementations, a computer platform 610 may include a semiconductor package 630 that, in turn, may include one or multiple semiconductor dies 640. As depicted in FIG. 6, in accordance with example implementations, FCG engines 101 are fabricated in the semiconductor dies 640. The FCG engine 101 includes one or multiple FCG state sequence detectors 652 that are coupled to coverage elements 644 of the semiconductor die(s) 640. Here, the coverage elements 644 may pertain to a subset of elements fabricated in the semiconductor die(s) 640. In this manner, the elements of the semiconductor die(s) 640 provide various features and/or capabilities that correspond to functionalities of the semiconductor package 630. In accordance with example implementations, the FCG state sequence detector 652 detects FCG cycles associated with a given functionality and provides an FCG indicator that represents a number of times that the functionality is exercised.

In accordance with example implementations, a usage monitor 650 of the FCG engine 101 may, based on the FCG indicators, calculate usage metrics that characterize the usage of the functionalities. For example, the usage metrics may be statistics (e.g., means, medians, expected values, variances, or other statistics) characterizing the usage of the functionalities. The usage monitor may be coupled to a communication interface 660 and with the permission of the owner of the computer platform 610 (or other appropriate user), or responsive to being allowed by another policy, may send the usage metrics via the network fabric 670 to the remote computer system 680 for analysis by the performance and analytics engine 684.

The performance and analytics engine 684 may analyze the usage metrics for semiconductor packages 630 on different computer platforms 610 for a variety of different purposes. For example, the analysis by the performance and analytics engine 684 may reveal to the manufacturer of the semiconductor package 630 or to the manufacturer of the computer platform 610 whether particular functionalities of the semiconductor package 630 are actually being used by customers.

As a specific example, in accordance with some implementations, the semiconductor package 630 may be a management controller for the computer platform 610, such as, for example, a baseboard management controller (BMC), and for these implementations, the remote computer system 680 may be, for example, a remote management server that is coupled via a management network to the BMCs of the computer platforms 610.

In the context used herein, a “BMC,” or “baseboard management controller,” is a specialized service processor that monitors the physical state of a server or other hardware using sensors and communicates with a management system through a management network. The baseboard management controller may also communicate with applications executing at the operating system level through an input/output controller (IOCTL) interface driver, a representational state transfer (REST) application program interface (API), or some other system software proxy that facilitates communication between the baseboard management controller and applications. The baseboard management controller may have hardware level access to hardware devices that are located in a server chassis including system memory. The baseboard management controller may be able to directly modify the hardware devices. The baseboard management controller may operate independently of the operating system of the system in which the baseboard management controller is disposed. A baseboard management controller may be located on the motherboard or main circuit board of the server or other device to be monitored.

The fact that a baseboard management controller is mounted on a motherboard of the managed server/hardware or otherwise connected or attached to the managed server/hardware does not prevent the baseboard management controller from being considered “separate” from the server/hardware. As used herein, a baseboard management controller has management capabilities for subsystems of a computing device, and is separate from a processing resource that executes an operating system of a computing device. The baseboard management controller is separate from a processor, such as a central processing unit, which executes a high-level operating system or hypervisor on a system.

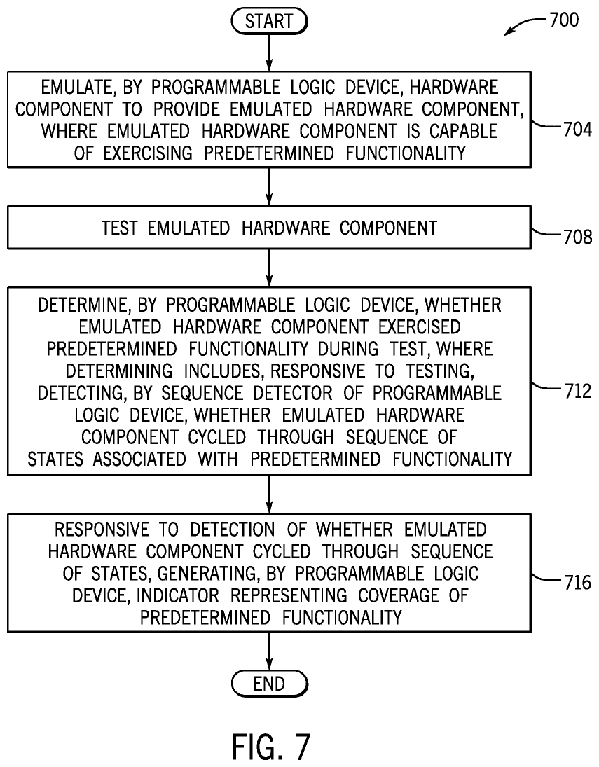

Referring to FIG. 7, in accordance with example implementations, a process 700 includes emulating (block 704), by a programmable logic device, a hardware component to provide an emulated hardware component. The emulated hardware component is capable of exercising a predetermined functionality. The process 700 includes testing (block 708) the emulated hardware component. The process 700 includes determining (block 712), by the programmable logic device, whether the emulated hardware component exercised the predetermined functionality during the test. The determination includes, responsive to the testing, detecting, by a state sequence detector of the programmable logic device, whether the emulated hardware component sequenced through a plurality of states associated with the predetermined functionality.

In accordance with some implementations, the state sequence detector may be configured by a table of configuration data that is stored in a memory of the programmable logic device. The data may, for example, specify a number of states of the state sequence detector and may further specify dependency conditions that the state sequence detector evaluates for purposes of controlling transitions among the states. In accordance with some implementations, the configuration table may further include data that represents a minimum number of times for the predetermined functionality to be exercised in order for the predetermined functionality to be considered to be covered. In accordance with some implementations, the programmable logic device may provide a plurality of state sequence detectors to provide coverage information for a plurality of functionalities of the emulated hardware component. In accordance with some implementations, the emulated hardware component may be a management controller for a computer platform, such as, for example, a baseboard management controller. In accordance with some implementations, the state sequence detector may be created via a register-transfer-logic (RTL) description, which is transformed into a corresponding netlist that describes the components of the state sequence detector. In accordance with some implementations, the state sequence detector may be initialized responsive to a power on or reset of the programmable logic device.

The process 700 includes, responsive to the detection of whether the emulated hardware component sequenced through the plurality of states, generating (block 716), by the programmable logic device, an indicator representing a coverage of the predetermined functionality by the testing. In accordance with some implementations, the indicator may be a binary indication that represents whether or not the predetermined functionality was exercised a predefined minimum number of times. In accordance with further implementations, the indicator may be a multiple bit indication that represents a number of times that the predetermined functionality was exercised.

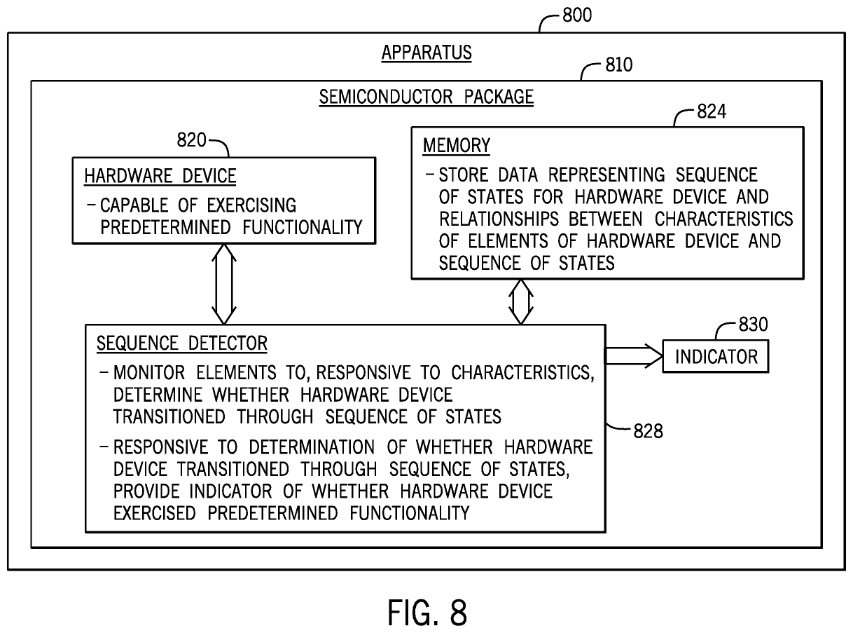

Referring to FIG. 8, in accordance with example implementations, an apparatus 800 includes a semiconductor package 810. The semiconductor package 810 includes a hardware device 820, a memory 824, and a state sequence detector 828. The hardware device 820 includes a plurality of elements, and the hardware device is capable of exercising a predetermined functionality. The memory 824 stores data representing a sequence of states for the hardware device and relationships between characteristics of the elements and the sequence of states.

The memory 824 may further store, in accordance with example implementations, data that represents a number of times for the predetermined functionality to be exercised for purposes of the predetermined functionality being covered. In accordance with example implementations, the hardware device 820 may include one or multiple counters that are associated with the state sequence detector 828 for purposes of allowing the state sequence detector 828 to measure time at different time increments via the counters. In accordance with some implementations, the semiconductor package 810 may be a programmable logic device. In accordance with further implementations, the semiconductor package 810 may be a fabricated integrated circuit. In accordance with some implementations, the semiconductor package 810 may include a communication interface and a usage monitor that communicates statistics regarding functional coverages to a remote server. The state sequence detector 828 monitors the elements to, responsive to the characteristics, determine whether the hardware device transitioned through the sequence of states.

The state sequence detector 828, responsive to the determination of whether the hardware device 820 transitioned through the sequence of states, provides an indicator 830 of whether the hardware device 820 exercised the predetermined functionality. In accordance with some implementations, the indicator 830 may be a binary indication that represents whether or not the predetermined functionality was exercised a predefined minimum number of times. In accordance with further implementations, the indicator 830 may be a multiple bit indication that represents a number of times that the predetermined functionality was exercised.

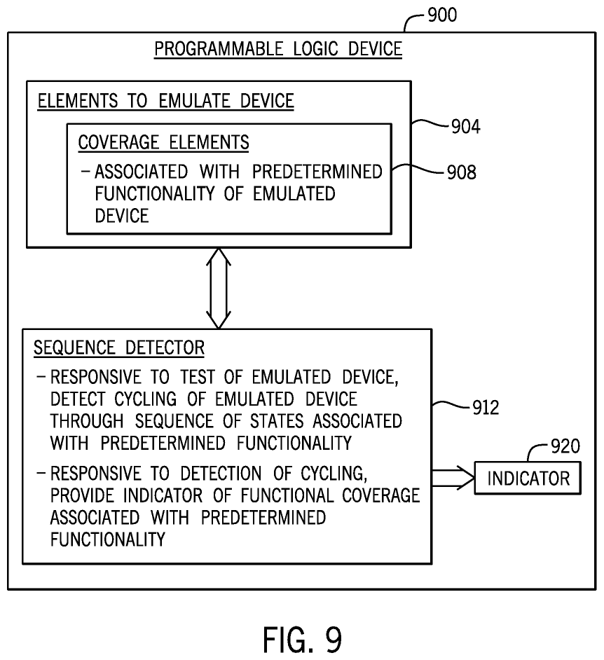

Referring to FIG. 9, in accordance with example implementations, a programmable logic device 900 includes a plurality of elements 904, and a state sequence detector 912. The elements 904 emulate an electronic device to provide an emulated device. The elements 904 include a plurality of coverage elements 908 that are associated with a predetermined functionality that is capable of being performed by the emulated device. In accordance with some implementations, the programmable logic device 900 may be a complex programmable logic device (CPLD), a field programmable gate array (FPGA) or an erasable programmable logic device (EPLD). In accordance with some implementations, the plurality of elements 904 may include logic gates, flip-flops, counters, synchronous logic, combinatorial logic, interconnects, nodes, wires, input/output (I/O) blocks or functional blocks. In accordance with some implementations, the elements 908 may include one or multiple functionality coverage indicators.

The state sequence detector 912 is coupled to the elements to, responsive to a test of the emulated device 904, detect cycling of the emulated device through a sequence of states associated with the predetermined functionality. The sequence detector 912, responsive to the detection of cycling, provides an indicator 920 of functional coverage associated with the predetermined functionality.

In accordance with some implementations, the indicator 920 may be a binary indication that represents whether or not the predetermined functionality was exercised a predefined minimum number of times. In accordance with further implementations, the indicator 920 may be a multiple bit indication that represents the number of times that the predetermined functionality was exercised.

In accordance with example implementations, the sequence detector may be configured by a configuration table of data, which is stored in the programmable logic device. In accordance with some implementations, the configuration table may store data representing a number of the states and dependency conditions that the sequence detector evaluates for purposes of transitioning among the states. In accordance with some implementations, the table may store data that represents a repeat cycle count, which represents a minimum number of times for the predetermined functionality to be exercised in order for the predetermined functionality to be covered. In accordance with some implementations, the programmable logic device may initialize the sequence detector in response to a power on or reset of the programmable logic device.

In accordance with example implementations, detecting whether the emulated hardware component sequenced through the plurality of states includes determining, by the state sequence detector, whether the emulated hardware component transitioned from a first state to a second state. In determining whether the emulated hardware component transitioned from the first state to the second state includes determining, by the state sequence detector, whether a conditional dependency group of a plurality of conditional dependency groups associated with the first state is satisfied. A particular advantage is that functionality coverage reporting for an emulated hardware component may be enhanced.

In accordance with example implementations, determining whether the conditional dependency group is satisfied includes determining, by the state sequence detector, whether the characteristics of a set of elements of the emulated hardware component satisfies the condition that is associated with the conditional dependency group. A particular advantage is that functionality coverage reporting for an emulated hardware component may be enhanced.

In accordance with example implementations, determining whether the emulated hardware component exercised the predetermined functionality further includes determining whether the emulated hardware component sequenced through the plurality of states a predetermined number of times. A particular advantage is that functionality coverage reporting for an emulated hardware component may be enhanced.

In accordance with example implementations, determining whether the emulated hardware component exercised the predetermined functionality further includes accessing a table that is stored in the programmable logic device. The table includes data that defines the plurality of states. A particular advantage is that functionality coverage reporting for an emulated hardware component may be enhanced.

In accordance with example implementations, the table is updated via an interface of the programmable logic device. A particular advantage is that functionality coverage reporting for an emulated hardware component may be enhanced.

In accordance with example implementations, determining whether the emulated hardware component exercised the predetermined functionality further includes accessing a table that is stored in the programmable logic device. The table includes data that defines the predetermined number of times. A particular advantage is that functionality coverage reporting for an emulated hardware component may be enhanced.

In accordance with example implementations, generating the indicator includes generating an indication of a number of times that the hardware component sequenced through the plurality of states. A particular advantage is that functionality coverage reporting for an emulated hardware component may be enhanced.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
emulating, by a programmable logic device, a hardware component to provide an emulated hardware component, wherein the emulated hardware component is capable of exercising a predetermined functionality;
testing the emulated hardware component;
determining, by the programmable logic device, whether the emulated hardware component exercised the predetermined functionality during the test, wherein the determining comprises, responsive to the testing, detecting, by a state sequence detector of the programmable logic device, whether the emulated hardware component sequenced through a plurality of states associated with the predetermined functionality; and
responsive to the detection of whether the emulated hardware component sequenced through the plurality of states, generating, by the programmable logic device, an indicator representing a coverage of the predetermined functionality by the testing.

2. The method of claim 1, wherein:
detecting whether the emulated hardware component sequenced through the plurality of states comprises determining, by the state sequence detector, whether the emulated hardware component transitioned from a first state of the plurality of states to a second state of the plurality of states; and
determining whether the emulated hardware component transitioned from the first state to the second state comprises determining, by the state sequence detector, whether a conditional dependency group of a plurality of conditional dependency groups associated with the first state is satisfied.

3. The method of claim 2, wherein determining whether the conditional dependency group is satisfied comprises determining, by the state sequence detector, whether characteristics of a set of elements of the emulated hardware component satisfies a condition associated with the conditional dependency group.

4. The method of claim 1, wherein determining whether the emulated hardware component exercised the predetermined functionality further comprises determining whether the emulated hardware component sequenced through the plurality of states a predetermined number of times.

5. The method of claim 4, wherein determining whether the emulated hardware component exercised the predetermined functionality further comprises accessing a table stored in the programmable logic device, wherein the table comprises data defining the plurality of states.

6. The method of claim 5, further comprising updating the table via an interface of the programmable logic device.

7. The method of claim 4, wherein determining whether the emulated hardware component exercised the predetermined functionality further comprises accessing a table stored in the programmable logic device, wherein the table comprises data defining the predetermined number of times.

8. The method of claim 1, wherein the emulated hardware component comprises a plurality of elements associated with the predetermined functionality, and determining whether the emulated hardware component exercised the predetermined functionality further comprises tracking transitions among the plurality of states responsive to values provided the plurality of elements.

9. The method of claim 1, wherein generating the indicator comprises generating an indication of a number of times that the hardware component sequenced through the plurality of states.

10. An apparatus comprising:
a semiconductor package comprising:
a hardware device comprising a plurality of elements, wherein the hardware device is capable of exercising a predetermined functionality;
a memory to store data representing a sequence of states for the hardware device and relationships between the characteristics of the elements and the sequence of states; and
a state sequence detector to:
monitor the elements to, responsive to the characteristics, determine whether the hardware device transitioned through the sequence of states; and
responsive to the determination of whether the hardware device transitioned through the sequence of states, provide an indicator of whether the hardware device exercised the predetermined functionality.

11. The apparatus of claim 10, wherein the indicator represents whether a functional coverage associated with the predetermined functionality was covered.

12. The apparatus of claim 11, wherein the data further represents a count of a number of times for the hardware device to transition through the sequence of states for the functionality to be covered.

13. The apparatus of claim 10, wherein the semiconductor package further comprises:
a usage monitor to, responsive to the indicator, determine a statistic representing a usage of the predetermined functionality; and
a communication engine to communicate data representing the statistic with a remote computer system.

14. The apparatus of claim 13, wherein the communication engine to regulate the communication of the data with the remote computer system responsive to a user authorization policy.

15. The apparatus of claim 10, wherein the semiconductor package is part of a baseboard management controller, and the apparatus further comprises a processing core to execute machine readable management stack instruction to provide management functions for a computer platform.

16. A programmable logic device comprising:
a plurality of elements to emulate an electronic device to provide an emulated device, wherein the plurality of elements comprises a plurality of coverage elements associated with a predetermined functionality of the emulated device; and
a state sequence detector coupled to the plurality of coverage elements to:
responsive to a test of the emulated device, detect cycling of the emulated device through a sequence of states associated with the predetermined functionality; and
responsive to the detection of the cycling, provide an indicator of a functional coverage associated with the predetermined functionality.

17. The programmable logic device of claim 16, further comprising:
a memory coupled to the state sequence detector, wherein the memory to store data representing criteria used by the state sequence detector to determine whether the emulated device transitions through the predetermined sequence of states during the test.

18. The programmable logic device of claim 17, wherein the data further represents sets of dependency groups, wherein each set of dependency groups representing at least one criterion to be satisfied for a state transition of the sequence of states.

19. The programmable logic device of claim 17, wherein the data further represent a plurality of dependency groups for a first state of the sequence of states, wherein each dependency group of the plurality of dependency groups represents at least one criterion to be satisfied for the device to transition from the first state to a second state of the plurality of states, and the state sequence detector determines that the device transitions from the first state to the second state responsive to the at least one criterion of any dependency group of the plurality of dependency groups being satisfied.

20. The programmable logic device of claim 17, wherein the data further represents a number of cycles of the sequence of states before the state sequence detector determines that the device exercised the predetermined functionality.
